(19) United States
(12) Patent Application Publication
(10) Pub. No.: US 2022/0311291 A1
(43) Pub. Date: Sep. 29, 2022

(54) STATOR FOR AN ELECTRIC MACHINE

(71) Applicant: Miba eMobility GmbH, Laakirchen (AT)

(72) Inventors: Andreas EILENBERGER, Lengenfeld (AT); Robert MIESBAUER, Pettenbach (AT)

(73) Assignee: Miba eMobility GmbH, Laakirchen (AT)

(21) Appl. No.: 17/616,317

(22) PCT Filed: Jun. 26, 2020
(86) PCT No.: PCT/AT2020/060254

§ 371 Date: Dec. 3, 2021

(30) Foreign Application Priority Data
Jun. 28, 2019 (AT) A50591/2019

(51) Int. Cl. H02K 1/16; H02K 3/28

(52) U.S. Cl. CPC H02K 1/165; H02K 3/28

(57) ABSTRACT

A stator for an electrical machine includes an essentially hollow-cylindrical stator core with receiving grooves. Each receiving groove is bounded at least by opposing groove side walls and by a groove base surface. In each receiving groove are electrical conductor rods with a rectangular cross-section, which form a stator winding by predefined electrical connections. At least one structurally-independent electrical insulation layer is in each receiving groove for electrically insulating conductor rods from one another or from the stator core. A subset of the conductor rods in each receiving groove is wrapped by the insulation layer which is double-layered between at least one of the side surface of the wrapped subset and the nearest assigned groove side wall or the nearest assigned receiving groove side walls. Compared to the further electrical conductor rods in this receiving groove, this wrapped subset is assigned nearest to the groove base surface of this receiving groove.

The invention relates to a stator for an electrical machine as specified in the claims.

Stators for electrical machines, provided with so-called rod windings have a basic structure as it is specified in the introductory part of the main claim. In this regard, multiple electrical conductor rods are, in each case, accommodated in a plurality of receiving grooves of a hollow-cylindrical, metallic stator core. The electrical conductor rods of this rod winding are typically provided with a permanently adhering electrical insulation coat, usually a plastic lacquer layer, over a significantly predominant part of their lateral surface. In order to further improve this electrical insulation, at least one insulation layer, in particular a so-called groove paper, may be provided additionally. This insulation layer formed per receiving groove lines the walls of the receiving grooves and thus increases the electrical insulation capacity between the conductor rods and the stator core.

An initially described stator embodiment is known from DE102014105425A1. In this regard, the groove lining is formed by a first insulation element with an essentially U-shaped cross-section and by a second insulation element with an equally essentially U-shaped cross-section. The limb end sections of these two insulation elements overlap one another, wherein the two insulation elements cooperate such that they define a sleeve-type groove lining with an essentially rectangular cross-section. In the region of the overlapping zone of the two insulation elements, one clearance is formed in each of the two groove side walls to create a consistent, clear receiving width for the electric conductor rods over the entire length of these two-part groove lining Especially in multi-phase stator windings with relatively high phase voltages, the conductor insulation present on the conductor elements may be insufficient.

JP2012-222983A discloses a stator of an electrical machine, in which the insulation paper formed in the receiving grooves of the stator is to be better protected from damage. Here, the receiving grooves of the stator have a first, relatively narrow receiving section for conductor elements with a relatively small diameter, and a second, comparatively wide receiving section for conductor elements with a relatively large diameter. The second, comparatively wide receiving section is positioned further outside in the radial direction toward the stator axis than the first, relatively narrow receiving section. The conductor elements respectively inserted into the two receiving sections have circular cross-sections, and the transitional sections between the narrow receiving section and the comparatively wide receiving section are formed by inclined transitional walls extending in an obtuse-angled manner, whereby the loads acting on the insulation paper are to be kept as low as possible. By means of an insulation paper with an S-shaped or eight-shaped cross-section, a single or double layer thickness of insulation paper can be formed between the conductor elements of the narrow and the wide receiving section. The conductor elements having the circular cross-section being in the receiving groove cause a relatively low filling factor of the receiving grooves with the electrically conductive material of the conductor elements, whereby the performance values of such a stator are satisfactory only to a limited extent.

The object of the present invention was to overcome the disadvantages of the prior art and to provide a stator for an electrical machine, which can offer high motor performance values with a compact structure while still achieving the greatest possible robustness and technical reliability.

The object is achieved by a stator for electrical machines as defined in the claims.

The stator according to the invention for an electrical machine comprises an essentially hollow-cylindrical stator core with a first and a second axial end face with multiple receiving grooves arranged distributed along a circumferential direction of the stator core and extending along a longitudinal axis of the stator core. Each of the receiving grooves is limited at least by opposing groove side walls and by a groove base surface. For each receiving groove, a plurality of electrical conductor rods is provided, which conductor rods have a rectangular cross-section and form a stator winding by means of predefined electrical connections. Additionally, at least one electrical insulation layer designed to be structurally independent is provided in each of the receiving grooves, which serve to electrically insulate individual conductor rods from one another or from the stator core.

A subset of the conductor rods in each of the receiving grooves, i.e. at least one of the conductor rods up to a predefined portion of the total number of conductor rods present per receiving groove, is wrapped, in particular preferably completely surrounded, by the insulation layer preferably formed in one part. In this regard, the insulation layer is designed to be double-layered, i.e. extending in a double-layered manner, between at least one of the side surfaces of the wrapped subset of the conductor rods and the closes assigned groove side wall or the nearest assigned groove side walls of the receiving groove, wherein the accordingly wrapped subset of the conductor rods is assigned, compared to the further electrical conductor rods in this receiving groove, to be nearest to the groove base surface of this receiving groove.

Thus, at least the subset of the conductor rods nearest to the groove base is wrapped by the insulation layer with respect to the cross-sectional circumference and/or the outer lateral surfaces, wherein this subset of conductor rods is insulated in a double-layered manner on at least one side surface opposite the groove side wall. Due to this embodiment, good electrical insulation values one the one hand, and, on the other hand, also the highest possible filling factors of the receiving grooves of the stator with the material of the electrical conductor rods can be achieved, which has a positive effect on the electrical performance values of the stator. Simultaneously, this increases that threshold value at which a certain amount of magnetic saturation arises in the so-called tooth sections of the stator, whereby a magnetic tooth saturation arises comparatively later, and the electromagnetic losses can be kept low even with a compact structure of the stator core. Furthermore, the embodiment according to the invention helps achieve that undesired current creepage paths between the conductor rods and the typically metallic stator core are impeded. Additionally, relatively high phase voltages at the stator winding also do not lead to undesired creepage paths since potential creepage paths at the ends of the insulation layer can be eliminated by means of the at least one double-layered section in the electrical insulation layer.

An embodiment in which the insulation layer runs double on both opposing side surfaces of the wrapped subset of the conductor rods is also advantageous. Thereby, it is advantageously achieved that on each of the two winding ends and/or winding end sections of the film-like insulation layer, one overlap with partial sections of this insulation layer positioned in between is ensured. Thereby, a high degree of prevention and/or inhibition of undesired current creepage paths between the electrical conductor rods and the metallic stator core can be achieved.

An advantageous embodiment consists in that the insulation layer has two layers only within a partial section of the radial depth of the receiving groove. Thereby, an excessive reduction of the material cross-section and/or the tooth width of the stator teeth can be impeded and thus, as high a magnetic saturation limit as possible of the stator teeth can be achieved. Nevertheless, it is thereby possible to meet high electrical insulation requirements, in particular to prevent an occurrence of current creepage paths to an improved extent.

It may also be useful if the wrapped subset of the conductor rods is wrapped completely by the insulation layer with respect to its cross-sectional circumference. Thereby, it can be ensured that both between conductor rods of different phase voltages and between individual conductor rods and the stator core, improved electrical insulation values are present. Undesired short circuits and creeping currents can thereby be impeded.

In particular, it may be provided that the insulation layer begins at one of the two side surfaces of the subset of the conductor rods with its first end, extends approximately radially in the direction toward the longitudinal axis of the stator core, extends in parallel to the width direction of the receiving groove, extends in an approximately radial direction toward the groove base surface, and further, extends between the groove base surface and the subset of conductor rods back to its first end. This results in that the at least one conductor rods, which is/are wrapped by the insulation layer, is packed into the insulation layer starting from the side surface closest to a stator tooth and/or a groove side wall and is not enclosed starting from a flat side of the conductor rods, which would extend in parallel to the groove base surface. This achieves that effectively in the region of their “tooth necks”, meaning in the vicinity of the groove base surfaces, the stator teeth are electrically insulated with respect to the wrapped conductor rod and/or the wrapped conductor rods with an interposition of a double layer thickness of the intermediate layers. Thereby, the stator teeth have to be designed to taper only in the region of their “tooth necks”, in order to be able to accommodate this double layer thickness of the insulation layer. Due to the tapering of the stator teeth only present in the region of their “tooth necks”, magnetic losses are decreased, and/or higher magnetic saturation limits can be achieved thereby. In particular, a minor reduction of the width of the “tooth necks” by the thickness of the insulation paper only has a low impact on the value of the saturation magnetization. Additionally, by means of these measures, the individual conductor rods can be inserted into the receiving groove with as little clearance as possible and/or without causing large-scale air gaps, without the insulation layer being damaged or slipping during the insertion of the conductor rods into the receiving grooves. In this context, it is also easily possible that the insulation layer has a wrap angle of more than 360°, in particular of 380° to 540°, with respect to the subset of the conductor rods. Undesired creeping currents can thereby be reliably impeded. Additionally, the mechanical robustness and stability of the stator winding is facilitated thereby.

The rectangular conductor rods are preferably accommodated in the receiving grooves such that, with respect to the cross-section of the receiving groove and of the conductor rods, the long sides of the conductor rods are oriented in the circumferential direction of the stator core, and the short sides of the conductor rods are oriented essentially radial to the longitudinal axis of the stator core.

According to a particular embodiment, it may be useful if the insulation layer continues on in one part after a wrapping and/or winding of more than 360° with respect to the subset of the conductor rods, between the side surface of at least one further, radially adjacent conductor rod and the corresponding groove side wall, wherein the at least one further conductor rod is arranged immediately adjacent in the radial direction toward the wrapped subset of the conductor rods, the insulation layer then extends further in the width direction of the receiving groove, then further extends in an approximately radial direction between the opposite side wall of the at least one further conductor rod and the nearest assigned groove side wall towards the groove base surface, and in doing so, covers the nearest assigned side surface of the wrapped subset of the conductor rods in a double-layered manner at least in some sections. Thereby, the direction of winding stays the same and/or the winding direction of the insulation layer stays the same with respect to the conductor rods, meaning either always in the clockwise direction or always in the counter-clockwise direction. This easily enables the insulation layer to have two layers on the opposing groove side walls in their partial sections closest to the groove base surface. This additionally facilitates the robustness and the ease of installation of the stator as the double-layered character of the insulation layer in the vicinity of the groove base surface facilitates the insertability and/or position stability of the insulation layer with respect to the individual receiving grooves. In particular, this also allows improving the efficiency of the stator with respect to production and use.

Furthermore, it may be provided that the insulation layer is formed in one part for wrapping the subset of the conductor rods and the at least one further conductor rod. On the one hand, this facilitates the stability of the insulation layer when inserting the conductor rods into the receiving grooves and/or into the enveloping spaces and/or partial chambers of the folded insulation layer. Furthermore, a production process with the greatest possible process stability and efficiency can be achieved thereby.

In contrast to a one-part embodiment, it may be provided that the insulation layer is formed in two parts, wherein its first insulation layer part and its second insulation layer part cooperate such that together, they realize a wrap angle of more than 360° with respect to the subset of the conductor rods. Thereby, the wrap angle section of the insulation layer is formed in two parts, which allows a staggered and/or delayed insertion of the insulation layer. In particular, thereby, the outer lining can advantageously be inserted into the receiving groove first, and subsequently, the second insulation layer part acting as a separating web can be inserted. This is true particularly when the first insulation layer part has an essentially U-shaped cross-section, and its base section forms an insulation coat effective in the radial direction between the subset of the conductor rods and the further conductor rod. The insertion behavior and/or the mountability of the insulation layer and the individual conductor rods in the receiving groove may be facilitated thereby.

According to a particular embodiment, it is possible that a stator tooth, which is formed between two receiving grooves immediately adjacent in the circumferential direction of the stator core, comprises a recess and/or a clearance for accommodating and/or receiving a layer of the double-layered insulation layer in at least one of the two groove side walls in the partial section closest to the groove base surface. This causes a tooth tapering in the section closest to the groove base surface, whereby as high a threshold value as possible up until the occurrence of the magnetic saturation of the stator tooth can be reached. Moreover, a completely symmetrical or at least largely symmetrical design of the stator teeth can be achieved thereby. A complete symmetry of the stator teeth with respect to a view parallel to the stator longitudinal axis is given if the stator tooth has at least one recess on each of its two limiting surfaces following one another in the circumferential direction.

It is also useful if a smallest tooth width of the stator tooth measured in the circumferential direction is greater in the section with the at least one recess than a smallest tooth width of the stator tooth in its tooth tip or in its remaining section. Thereby, as high a magnetic saturation limit as possible can be achieved.

Moreover, it may be useful if two conductor rods, which are arranged immediately adjacently in the radial direction, define a conductor rod pair wrapped by the insulation layer. Thereby, it is achieved that multi-phase stator windings in rod conductor embodiment achieve better insulation parameters.

Furthermore, it may be provided that all conductor rods within a receiving groove have a same width with respect to the circumferential direction, and the receiving grooves of the stator core have a receiving cross-section which extends essentially rectangularly and/or is rectangularly bounded. Thereby, the highest possible filling factor of the receiving grooves with the material of the electrical conductor rods, which are made of copper, for example, is possible. This results in electromagnetic performance advantages of the stator and/or an improved ratio between the electromagnetic performance and the construction volume of the stator.

Furthermore, it may be provided that the first end section of the insulation layer defines an inner layer with respect to the side surfaces of the at least one conductor rod, and the second end section of the insulation layer defines an outer layer in the double-layered section of the insulation layer. Thereby, the self-retaining effect of the insulation layer can be improved so that an undesired shifting with respect to the receiving grooves during the joining operation of the conductor rods can be impeded. Additionally, an overall consistent direction of winding of the insulation layer with respect to the conductor rods can be maintained, whereby the dimensional stability of an accordingly folded insulation layer is facilitated, and/or the self-clamping effect and/or the outwardly-directed force effect of the insulation layer is improved. Joining and/or installation processes of the insulation layers and also of the conductor rods with respect to the receiving grooves can thereby be made simpler and can also be realized in a more process-safe manner This especially because the insulation layer thereby essentially extends in the manner of a spiral spring and/or is folded and/or preformed like a spiral spring. After inserting the corresponding insulation layer into the receiving grooves, the insulation layer has a widening behavior and/or an outward expansion tendency. Thereby, corresponding insulation layers can be inserted into the receiving grooves of the stator core with positional accuracy and also positional stability.

It is also advantageous if the insulation layer extends exclusively in a single-layered manner with respect to the radial direction of the longitudinal axis of the stator core. Thereby, there are no double layers of the insulation layer with respect to radially directly adjacent conductor rods. The electromagnetic performance of the stator can thereby be favored.

Finally, it may be provided that, with respect to conductor rods arranged within a receiving groove, a lateral offset with respect to the circumferential direction of the stator core is provided between groups of conductor rods arranged adjacent in the radial direction. Thereby, it is possible to provide a recess in only one of the two groove side walls and still realize a double-layered partial section of the insulation layer. Due to the loads and/or stresses acting on the insulation layer because of such recesses can thus be kept low and/or be reduced.

For the purpose of better understanding of the invention, it will be elucidated in more detail by means of the figures below.

These show in a respectively very simplified schematic representation:

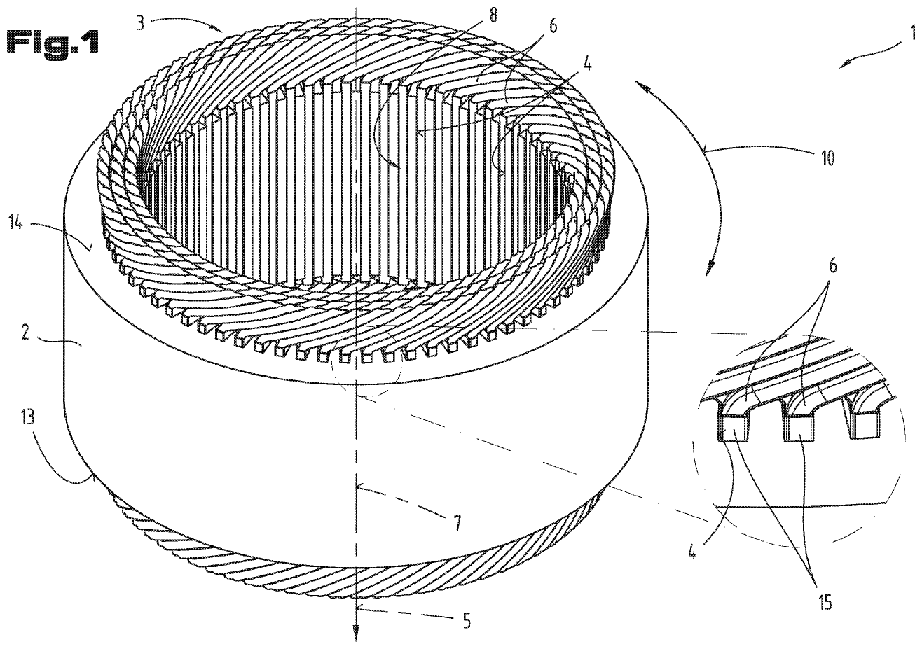

FIG. 1 a perspective view including a detailed view of an exemplary embodiment of a stator for an electrical machine;

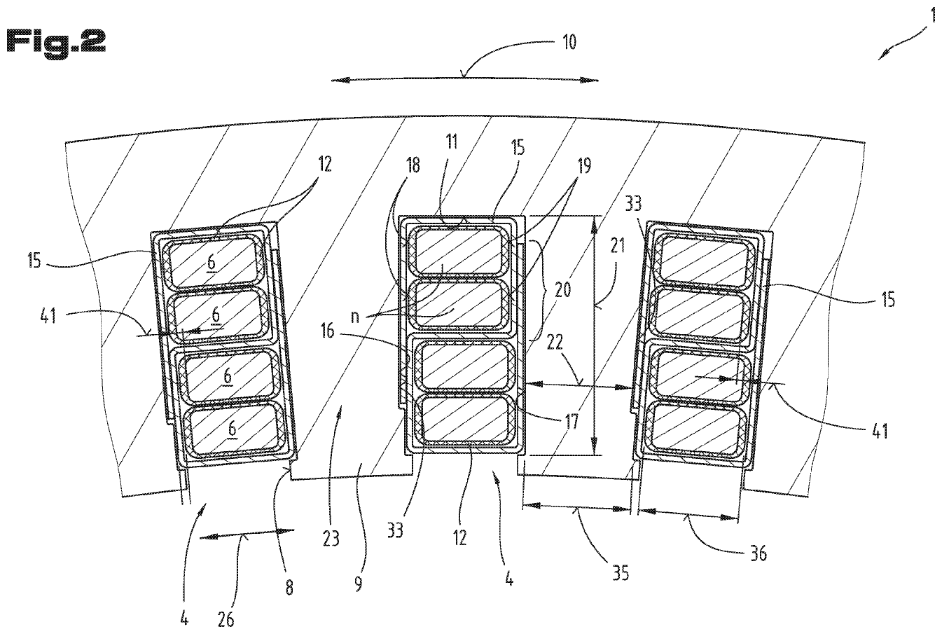

FIG. 2 a first embodiment variant of a stator in the region of three receiving grooves in a cross-sectional view;

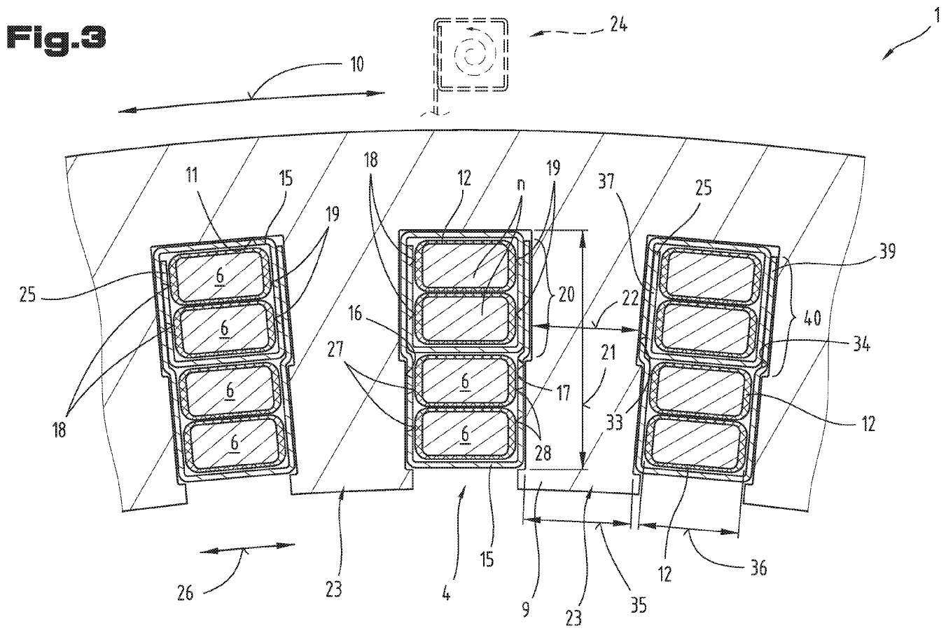

FIG. 3 a second embodiment variant of a stator in the region of three receiving grooves in a cross-sectional view;

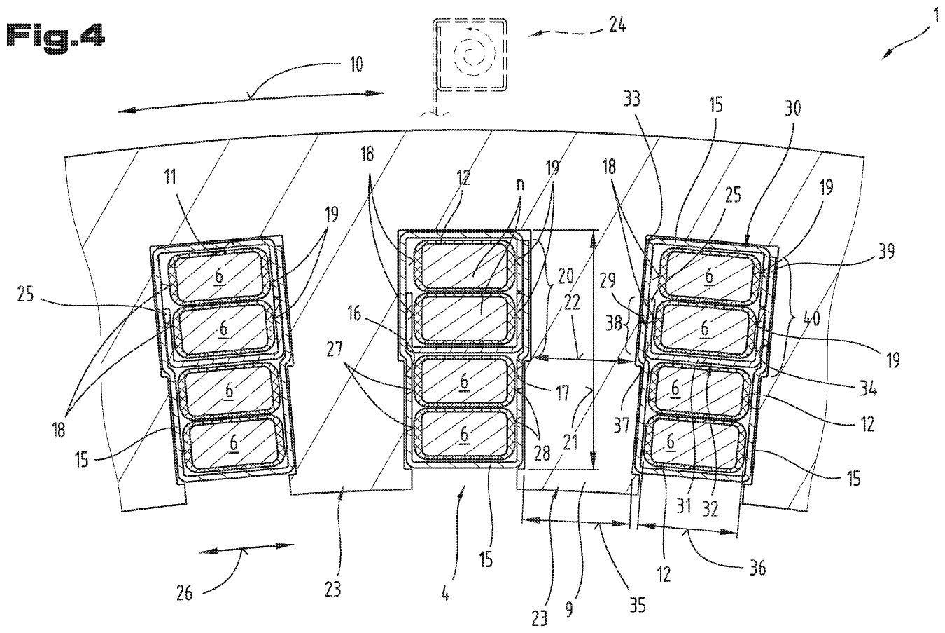

FIG. 4 a third embodiment variant of a stator in the region of three receiving grooves in a cross-sectional view.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

In FIG. 1, a stator 1 is shown highly schematically in an oblique view. In this regard, the stator 1 comprises an essentially hollow-cylindrical laminated core, in which a plurality of receiving grooves 4 are arranged distributed in the circumferential direction 10. This laminated core defines the so-called stator core 2. The receiving grooves 4 are, in this regard, formed continuously in the longitudinal and/or axial direction 5 of the stator core 2. From FIGS. 1 to 4, it can be gathered by way of example that in each of the receiving grooves 4, multiple electrical conductor rods 6 are provided, which define the at least one electrical coil and/or stator winding 3 by means of predefined electrical connections.

As can further be seen best from a combination of FIGS. 1 to 4, the receiving grooves 4 of the stator core 2 are designed to be open with respect to a radial direction of the hollow-cylindrical stator core 2 toward the central longitudinal axis 7 of the stator 1. Such openings may be designed as narrow and/or elongated gaps 8 on the inner wall surface and/or lateral surface of the stator core 2. Those sections of the stator core 2 which constrict and/or limit the receiving grooves 4 in the direction toward the central longitudinal axis 7 may be designed and/or designated as tooth tips 9 with respect to the circumferential direction 10. On the side of the respective receiving groove 4 opposite the tooth tips 9, also referred to as yoke side, the groove base surface 11 is located. The exact number of receiving grooves 4 and the electric conductor rods 6 received therein depend on the desired size and the design of the electric machine.

Basically, the receiving grooves 4 may have different cross-section shapes, wherein corresponding, rectangular cross-sections of the receiving grooves 4 have proven to work well for receiving electrical conductor rods 6. For insulating the individual electrical conductor rods 6 from one another and from the stator core 2, it is necessary to form at least one insulation layer 12 on the lateral surface of the conductor rods 6. In particular, the conductor rods 6 are each jacketed by one insulation coat 12 in at least their sections inside the stator core 2. As is known per se, this insulation coat 12 is designed as a coat of lacquer on the lateral surfaces of the conductor rods 6, which coat of lacquer may have been applied by means of a dipping method.

The essentially hollow-cylindrical stator core 2 has a first and a second axial end face 13, 14 with respect to its central longitudinal axis 7. The electrical conductor rods 6 in the receiving grooves 4 are formed by metallic shaped rods, preferably made of copper or a different material with good electrical conductivity. These shaped rods form a plurality of electrical conductor sections, which extend at least within the respectively assigned receiving grooves 4. In this regard, these conductor sections may be defined by so-called I-pins or by so-called hairpins.

A number of the electrical conductor rods 6 is thus arranged in each of the receiving grooves 4, and the stator winding 3 according to the plan is constructed by means of predefined electrical connections between the circularly positioned conductor rods 6, which stator winding 3 serves to generate a circumferential magnetic field when the stator 1 is supplied with single-phase or multi-phase electrical energy. As can be seen by way of example in FIG. 1 or in FIGS. 2 to 4, such a stator winding 3, in an operational state, has multiple layers of conductor rods 6 immediately adjacent in the radial direction towards the central longitudinal axis 7 of the stator core 2. The supply of single-phase alternating current or of multi-phase alternating current (rotary current) is carried out via dedicated connection points, which are not shown in more detail, on the stator winding 3, as is generally known.

Additionally, at least one electrical insulation layer 15 constructed in a structurally independent manner is formed in each of the receiving grooves 4, which insulation layer 15 is provided for electrical insulation of individual conductor rods 6 from one another and/or with respect to the stator core 2.

Each of the slot-like receiving grooves 4 on the inner lateral surface of the hollow-cylindrical stator core 2 comprises groove side walls 16, 17 extending angularly, in particular orthogonally, to the groove base surface 11, as can best be seen in FIGS. 2 to 4. When viewed in the cross-section of the receiving grooves 4, the pairs of opposing groove side walls 16, 17 per receiving groove 4 run in parallel to one another, so that so-called parallel-flanked receiving grooves 4 are formed in the stator core 2. These groove side walls 16, 17 oriented in parallel to one another may also run in a steplike manner and/or be provided with recesses 33, 34, as can be gathered by way of example from FIGS. 2 to 4. Despite such recesses 33, 34, the respectively formed partial surfaces of the groove side walls 16, 17 remain in parallel orientation to one another.

A predefined subset n of the conductor rods 6 in each receiving groove 4, i.e. n=1 to n=x−1, is wrapped and/or completely surrounded by the insulation layer 15 preferably formed in one part, as can be seen by way of example in FIGS. 2, 3. In this regard, variable x stands for the total number of conductor rods 6 present per receiving groove 4. As shown in the embodiment variant according to FIG. 4, the insulation layer 15 in the receiving grooves 4 may also be formed in two parts and/or comprise more than two insulation layer parts 29, 30 designed to be structurally separate.

This wrapping of a subset n of the total conductor rods 6 present per receiving groove 4 is designed such that the insulation layer 15 is designed to be double-layered between at least one of the side surfaces 18, 19 of the wrapped subset n of the conductor rods 6 and the nearest assigned groove side wall 16 or 17 or the nearest assigned groove side walls 16 and 17 of the receiving groove 4. FIG. 2 shows that the insulation layer 15 extends in two layers at exactly one of the two side surfaces 18, 19 of the wrapped subset n of the conductor rods 6, namely only on the side surface 19. However, the insulation layer 15 may also extend in two layers on the two opposing side surfaces 18, 19 of the wrapped subset n of the conductor rods 6 at least in some sections, as can be seen in FIG. 3 and in FIG. 4.

Compared to the further and/or remaining electrical conductor rods 6 in the same receiving groove 4, this wrapped subset n of the conductor rods 6 is selected such that this subset n is assigned nearest to the groove base surface 11 of this receiving groove 4, as can be gathered from FIGS. 2 to 4. Thus, the wrapped subset n of the conductor rods 6 is arranged so as to be distanced and/or removed from the gap 8 and/or from the tooth tip 9.

As shown in the embodiments according to FIG. 2 to FIG. 4, it is useful if the insulation layer 15 is designed to be double-layered only and/or exclusively within a partial section 20 of the total formed radial depth 21 of the receiving groove 4. Thereby, the reduction of the tooth width 22 of the individual stator teeth 23 measured in the circumferential direction 10 can be kept low, and the undesired occurrence of magnetic saturations in the stator teeth 23 is impeded. In particular, this helps achieve as high a threshold and/or transitional value as possible up until the occurrence of the magnetic saturation limit. A stator tooth 23 is a component of the stator core 2 and is formed, in each case, between two receiving grooves 4 immediately consecutive in the circumferential direction 10. The partial section 20 with the double-layered insulation layer 15 is preferably assigned nearest to the groove base surface 11, meaning it is formed to be distanced from the tooth tip 9, as can be gathered from FIGS. 2 to 4.

As can further be gathered from the embodiment variants according to FIGS. 2 to 4, the wrapped subset n of the conductor rods 6 is completely wrapped by the insulation layer 15 with respect to its cross-sectional circumference. As can be gathered especially from the embodiment variants according to FIG. 3 or according to FIG. 4, the insulation layer 15 may have a wrap angle 24 of more than 360°, in particular of 380° to 540°, with respect to the subset n of the conductor rods 6. Thereby, undesired creepage paths can be reliably impeded without causing an excessive reduction of the tooth width 22.

A useful wrapping by means of the insulation layer 15 is given when the insulation layer 15 begins at one of the two side surfaces 18, 19 of the subset n of the conductor rods 6 with its first end 25, extends approximately radially in the direction of the central longitudinal axis 7 of the stator core 2, extends in parallel to the width direction 26 of the receiving groove 4, extends in an approximately radial direction toward the groove base surface 11, and further, extends between the groove base surface 11 and the subset n of conductor rods 6 back to its first end 25, as can be gathered from FIG. 3 and FIG. 4. Such a wrapping of the subset n of conductor rods 6 can be advantageously realized such that, in advance, an accordingly folded insulation layer 15, in particular a so-called insulation paper, is inserted into the receiving grooves 4 and subsequently, the corresponding subset n of conductor rods 6 is pushed into the accordingly folded insulation layer 15.

As can further be gathered from FIGS. 3, 4, it may be useful if the insulation layer 15 continues on in one part after a wrapping and/or winding of more than 360° with respect to the subset n of the conductor rods 6, between the side surface 27 of at least one further, radially adjacent conductor rod 6 and the corresponding groove side wall 16, wherein the at least one further conductor rod 6 is arranged immediately adjacent in the radial direction toward the wrapped subset n of the conductor rods 6. The insulation layer 15 then extends further in the width direction 26 of the receiving groove 4, further in an approximately radial direction between the opposite side surface 28 of the at least one further conductor rod 6 and the nearest assigned groove side wall 17, in the direction toward the groove base surface 11, and in doing so, covers the nearest assigned side surface 19 of the wrapped surface n of the conductor rods 6 in a double-layered manner at least in some sections. Thus, the insulation layer 15 maintains its direction of winding with respect to all conductor rods 6 of the respective receiving groove 4. According to the embodiment variants in FIGS. 3, 4, this direction of winding is always counter-clockwise. Alternatively to this, a clockwise direction of winding is also possible. Thereby, as process stable an insertion operation as possible of the conductor rods 6 into the accordingly preformed insulation paper, which may be inserted into the receiving grooves 6 as an insulation layer 15 in advance, can be achieved. This can be explained by spiral spring like expansion tendencies of the insulation layer 15 with respect to the groove side walls 16, 17 and the groove base surface 11.

The spiral spring course of the insulation layer 15 in the receiving grooves 4 according to FIG. 3 and according to FIG. 4 is in contrast to the embodiment according to FIG. 2 with an S-shaped and/or an eight-shaped course of the insulation layer 15. In particular, in the embodiment according to FIG. 2, a change of the direction of winding is present and/or in this embodiment, both directions of winding occur in each receiving groove 4 in this embodiment.

As can be gathered from FIGS. 2 and 3, the insulation layer 15 for wrapping the subset n of the conductor rods 6 and simultaneously of at least one further conductor rod 6 may be formed in one part within a receiving groove 4. However, as an alternative, it may also be provided that the insulation layer 15 is formed in two parts, as is illustrated in FIG. 4. In this regard, the insulation layer 15 comprises a first insulation layer part 29 and a second insulation layer part 30. The two insulation layer parts 29, 30 cooperate such that, together, they realize a wrap angle 24 of more than 360° with respect to the subset n of the conductor rods 6, as is shown by way of example in FIG. 4. In this regard, it may be useful if the first insulation layer part 29 has an essentially U-shaped cross-section and its base section 31 forms an insulation coat 32 effective in the radial direction between the subset n of the conductor rods 6 and a further conductor rod 6 immediately adjacent in the radial direction.

In order to accommodate the double-layered sections of the insulation layer 15 in the receiving grooves 4 without jamming on the one hand, but while still reducing the tooth cross-sections and/or tooth widths 22 as little as possible, it is provided that the stator teeth 23 have, in their partial sections of the groove side walls 16, 17 closest to the groove base surface 11, at least one recess 33, 34 and/or corresponding clearances for accommodating and/or receiving a layer of the double-layered insulation layer 15. In this regard, the stator tooth 23 is to be understood as those sections of the stator core 2 which are formed between two receiving grooves 4 immediately adjacent in the circumferential direction 10. Undesired tapering of the tooth cross-section is thereby impeded and/or reductions of the tooth widths 22 are thereby only executed in the partial section 20 closest to the groove base surface 11. Thereby, the smallest existing tooth width 22 of the stator teeth 23 can be kept as great as possible. This applies due to the sector-like course of the stator teeth 23 with respect to the central longitudinal axis 7. In the embodiment according to FIG. 2, only a recess 33 is provided in the groove side wall 16, while in the embodiment according to FIG. 3 or 4, one recess 33, 34 is formed on each of the two groove side walls 16, 17 for accommodating the double-layered section of the insulation layer 15.

In particular, it is provided in the embodiment variant according to FIGS. 3, 4 that the stator tooth 23 has at least one recess 33, 34 on each of its two limiting surfaces following one another in the circumferential direction 10, in particular on both groove side walls 16, 17. Thereby, symmetrically tapering stator teeth 23 and/or symmetrically recessed limiting walls and/or groove side walls 16, 17 are obtainable.

Finally, it may be provided that a smallest tooth width 22 of the stator teeth 23 measured in the circumferential direction 10 continues to be greater and/or remains greater in the section with the at least one recess 33, 34 than a smallest tooth width 25 of the stator teeth 23 in their tooth tips 9 and/or in their remaining sections.

As can be gathered from the embodiments according to FIGS. 2 to 4, it is useful if two conductor rods 6 arranged to be immediately adjacent in the radial direction define a conductor rod pair wrapped by the insulation layer 15.

Furthermore, it may can be gathered from these embodiments that all conductor rods 6 within a receiving groove 4 have a same conductor width 36 related to the circumferential direction 10, and the receiving grooves 4 of the stator core 2 have a receiving cross-section which extends essentially rectangularly and/or is rectangularly bounded. Thereby, high filling factors of the receiving grooves 4 with the conductor material, for example copper, is possible in a simple manner Thereby, the performance advantages of the stator 1 and/or of an electrical machine constructed therewith can be achieved. Such an electrical machine may be designed as a motor or as a generator.

According to the wrapping embodiment according to FIG. 3 or according to FIG. 4, the first end 25 and/or the first end section 37 of the insulation layer 15 defines an inner layer 38 with respect to the side surfaces 18, 19 of the at least one conductor rod 6, and the second end section 39 of the insulation layer 15 defines an outer layer 40 in the double-layered section of the insulation layer 15. The self-retaining and/or self-clamping effect of the insulation layer 15 can be improved thereby. An undesired shifting of the insulation layer 15 previously inserted into the receiving groove 4 may thereby be impeded in the course of the joining operation with the conductor rods 6.

As can further be gathered from the embodiment variants according to FIGS. 2 to 4, it may be provided, in connection with the presented winding variants, that the insulation layer 15 extends exclusively in a single-layered manner with respect to the radial direction of the central longitudinal axis 7 of the stator core 2. In particular, there are no double layers between conductor rods 6 immediately following one another in the radial direction with respect to the radial direction of the hollow-cylindrical stator core 2.

In case of the winding principle according to FIG. 2, it may also be provided that, with respect to conductor rods 6 arranged within a receiving groove 4, a lateral offset 41 with respect to the circumferential direction 10 of the stator core 2 is provided between groups of conductor rods 6 arranged adjacent in the radial direction. This lateral offset 41 approximately corresponds to the thickness of the insulation layer 15. The lateral offset 41 can therefore amount to a few tenths of a millimeter to about one millimeter.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Stator |
| 2 | Stator core |
| 3 | Stator winding |
| 4 | Receiving groove |
| 5 | Axial direction |
| 6 | Conductor rods |
| 7 | Central longitudinal axis |
| 8 | Gap |
| 9 | Tooth tip |
| 10 | Circumferential direction |
| 11 | Groove base surface |
| 12 | Insulation coat |
| 13 | Axial end face |
| 14 | Axial end face |
| 15 | Insulation layer |
| 16 | Groove side wall |
| 17 | Groove side wall |
| 18 | Side surface |
| 19 | Side surface |
| 20 | Partial section |
| 21 | Radial depth |
| 22 | Tooth width |
| 23 | Stator tooth |
| 24 | Wrap angle |
| 25 | First end |
| 26 | Width direction |
| 27 | Side surface |
| 28 | Side surface |
| 29 | First insulation layer part |
| 30 | Second insulation layer part |
| 31 | Base section |
| 32 | Insulation ply |
| 33 | Recess |
| 34 | Recess |
| 35 | Smallest tooth width |
| 36 | Conductor width |
| 37 | First end section |
| 38 | Inner layer |
| 39 | Second end section |
| 40 | Outer layer |
| 41 | Lateral offset |
| n | subset |

1. A stator (1) for an electrical machine, comprising
an essentially hollow-cylindrical stator core (2) with a first and a second axial end face (13, 14) and with multiple receiving grooves (4) arranged distributed along a circumferential direction (10) of the stator core (2) and extending along a longitudinal axis (7) of the stator core (2), wherein each of the receiving grooves (4) is limited at least by opposing groove side walls (16, 17) and by a groove base surface (11),
a plurality of electrical conductor rods (6) per receiving groove (4), which conductor rods (6) have a rectangular cross-section and form a stator winding (3) by means of predefined electrical connections,
and at least one electrical insulation layer (15) designed to be structurally independent is provided in each of the receiving grooves (4) for electrically insulating conductor rods (6) from one another or from the stator core (2),
wherein
a subset (n) of the conductor rods (6) in each of the receiving grooves (4) is wrapped by the insulation layer (15),
the insulation layer (15) is designed to be double-layered between at least one of the side surfaces (18, 19) of the wrapped subset (n) of the conductor rods (6) and the nearest assigned groove side wall (16; 17) or the nearest assigned groove side walls (16, 17) of the receiving groove (4), and
compared to the further electrical conductor rods (6) in this receiving groove (4), this wrapped subset (n) of the conductor rods (6) is assigned nearest to the groove base surface (11) of this receiving groove (4).

2. The stator according to claim 1, in that wherein the insulation layer (15) runs double on the two opposing side surfaces (18, 19) of the wrapped subset (n) of the conductor rods (6).

3. The stator according to claim 1, wherein the insulation layer (15) is designed to be double-layered only within a partial section (20) of the radial depth (21) of the receiving groove (4).

4. The stator according to claim 1, wherein the wrapped subset (n) of the conductor rods (6) is wrapped completely by the insulation layer (15) with respect to its cross-sectional circumference.

5. The stator according to claim 4, wherein the insulation layer (15) begins at one of the two side surfaces (18; 19) of the subset (n) of the conductor rods (6) with its first end (25), extends approximately radially in the direction toward the longitudinal axis (7) of the stator core (2), extends in parallel to the width direction (26) of the receiving groove (4), extends in an approximately radial direction toward the groove base surface (11), and further, extends between the groove base surface (11) and the subset (n) of conductor rods (6) back to its first end (25).

6. The stator according to claim 1, wherein the insulation layer (15) has a wrap angle (24) of more than 360°, in particular of 380° to 540°, with respect to the subset (n) of the conductor rods (6).

7. The stator according to claim 1, wherein the insulation layer (15) continues in one part after a wrapping of more than 360° with respect to the subset (n) of the conductor rods (6), between the side surface (27) of at least one further, radially adjacent conductor rod (6) and the corresponding groove side wall (16), wherein the at least one further conductor rod (6) is arranged immediately adjacent in the radial direction to the wrapped subset (n) of the conductor rods (6), the insulation layer (15) then extends further in the width direction (26) of the receiving groove (4), then extends further in an approximately radial direction between the opposite side wall (28) of the at least one further conductor rod (6) and the nearest assigned groove side wall (17) towards the groove base surface (11), and in doing so, covers the nearest assigned side surface (19) of the wrapped subset (n) of the conductor rods (6) in a double-layered manner at least in some sections.

8. The stator according to claim 1, wherein the insulation layer (15) is formed in one part for wrapping the subset (n) of the conductor rods (6) and the at least one further conductor rod (6).

9. The stator according to claim 1, wherein the insulation layer (15) is formed in two parts, wherein its first insulation layer part (29) and its second insulation layer part (30) cooperate such that, together, they realize a wrap angle (24) of more than 360° with respect to the subset (n) of the conductor rods (6).

10. The stator according to claim 9, wherein the first insulation layer part (29) has an essentially U-shaped cross-section, and its base section (31) forms an insulation coat (32) effective in the radial direction between the subset (n) of the conductor rods (6) and a further radially adjacent conductor rod (6).

11. The stator according to claim 1, wherein a stator tooth (23), which is formed between two receiving grooves (4) immediately adjacent in the circumferential direction (10) of the stator core (2), comprises a recess (33, 34) for accommodating a layer of the double-layered insulation layer (15) in at least one of the two groove side walls (16, 17) in the partial section (20) closest to the groove base surface (11).

12. The stator according to claim 11, wherein the stator tooth (23) has at least one recess (33, 34) on each of its two limiting surfaces following one another in the circumferential direction (10), which are defined by groove side walls (16, 17) of receiving grooves (4) adjacent in the circumferential direction (10).

13. The stator according to claim 11, wherein a smallest tooth width (22) of the stator tooth (23) measured in the circumferential direction (10) is greater in the section with the at least one recess (33, 34) than a smallest tooth width (35) of the stator tooth (23) in its tooth tip (9) or in its remaining section.

14. The stator according to claim 1, wherein two conductor rods (6), which are arranged immediately adjacently in the radial direction, define a conductor rod pair wrapped by the insulation layer (15).

15. The stator according to claim 1, wherein all conductor rods (6) within a receiving groove (4) have a same conductor width (36) with respect to the circumferential direction (10), and the receiving grooves (4) of the stator core (2) have a receiving cross-section which extends essentially rectangularly.

16. The stator according to claim 1, wherein the first end section (37) of the insulation layer (15) defines an inner layer (38) with respect to the side surfaces (18, 19) of the at least one conductor rod (6), and the second end section (39) of the insulation layer (15) defines an outer layer (40) in the double-layered section of the insulation layer (15).

17. The stator according to claim 1, wherein the insulation layer (15) extends only in a single-layered manner with respect to the radial direction of the longitudinal axis (7) of the stator core (2).

18. The stator according to claim 1, wherein, with respect to conductor rods (6) arranged within a receiving groove (4), a lateral offset (41) with respect to the circumferential direction (10) of the stator core (2) is formed between groups of conductor rods (6) arranged adjacent in the radial direction.
